(19) United States
(12) Patent Application Publication
(10) Pub. No.: US 2026/0046140 A1
(43) Pub. Date: Feb. 12, 2026

(54) APPARATUS, METHOD OF OPERATING AN APPARATUS AND A COMPUTER PROGRAM

(71) Applicant: Arm Limited, Cambridge (GB)

(72) Inventors: Brendan Moran, Coton (GB); Gustavo Petri, Cambridge (GB)

(73) Assignee: Arm Limited, Cambridge (GB)

(21) Appl. No.: 19/100,109

(22) PCT Filed: Jun. 8, 2023
(86) PCT No.: PCT/GB2023/051490

§ 371 Date: Jan. 30, 2025

(30) Foreign Application Priority Data
Aug. 4, 2022 (GB) 2211398.9

(51) Int. Cl. H04L 9/32

(52) U.S. Cl. CPC H04L 9/3247

(57) ABSTRACT

There is provided an apparatus, a method of operating the apparatus and a computer program for controlling a host data processing apparatus to provide an instruction execution environment equivalent to the apparatus. The apparatus comprises processing circuitry configured to execute a sequence of program instructions to process data items. The processing circuitry is configured to generate a signature indicative of executed instructions in the sequence of program instructions and indicative of the data items. The apparatus is also provided with validation circuitry configured to implement a validation procedure. The validation procedure comprises the steps of evaluating the signature against a predefined policy to verify that the processing circuitry has processed the data items using the sequence of program instructions and, in response to a match between the signature and the predefined policy, generating confirmation information to indicate the match.

This invention relates to an apparatus, method of operating an apparatus and a computer program.

Apparatuses provided with processing circuitry are used to execute sequences of instructions in order to process data items. In some cases it is important to be able to verify, and provide information indicative of the verification, that a sequence of executed instructions is the intended sequence of instructions and that the data items that are processed are those that were intended.

According to a first aspect of the invention there is provided an apparatus comprising:
processing circuitry configured to execute a sequence of program instructions to process data items, wherein the processing circuitry is configured to generate a signature indicative of executed instructions in the sequence of program instructions and indicative of the data items; and
validation circuitry configured to implement a validation procedure comprising evaluating the signature against a predefined policy to verify that the processing circuitry has processed the data items using the sequence of program instructions and, in response to a match between the signature and the predefined policy, generating confirmation information to indicate the match.

According to a second aspect of the invention there is provided a method of operating an apparatus comprising processing circuitry, the method comprising:
executing, using the processing circuitry, a sequence of program instructions to process data items and generating a signature indicative of executed instructions in the sequence of program instructions and indicative of the data items; and
implementing a validation procedure comprising evaluating the signature against a predefined policy to verify that the processing circuitry has processed the data items using the sequence of program instructions and, in response to a match between the signature and the predefined policy, generating confirmation information to indicate the match.

According to a third aspect of the invention there is provided a computer program for controlling a host data processing apparatus to provide an instruction execution environment, comprising:
processing program logic configured to execute a sequence of program instructions to process data items, wherein the processing program logic is configured to generate a signature indicative of executed instructions in the sequence of program instructions and indicative of the data items; and
validation program logic configured to implement a validation procedure comprising evaluating the signature against a predefined policy to verify that the processing program logic has processed the data items using the sequence of program instructions and, in response to a match between the signature and the predefined policy, generating confirmation information to indicate the match.

The present techniques will be described further, by way of example only, with reference to configurations thereof as illustrated in the accompanying drawings, in which:

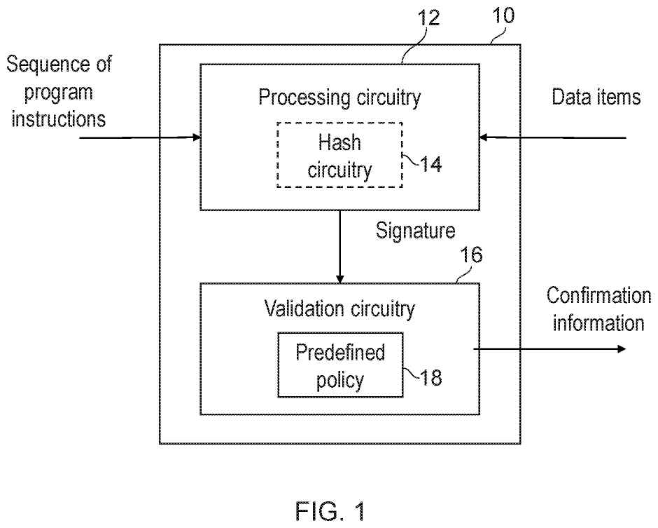

FIG. 1 schematically illustrates an apparatus according to various examples of the present techniques;

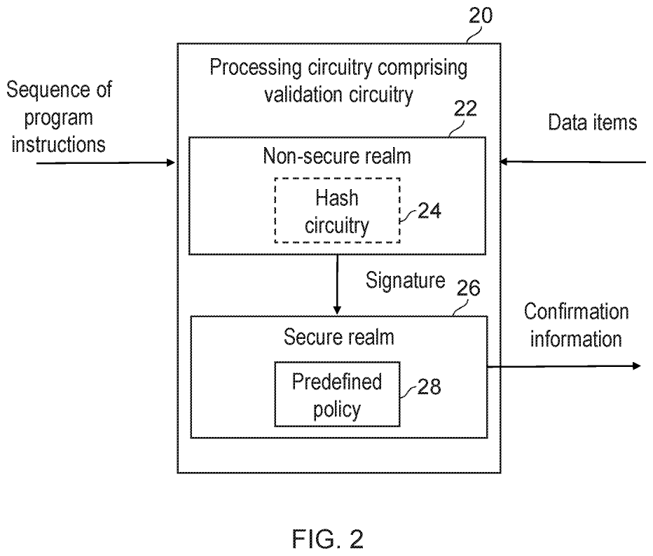

FIG. 2 schematically illustrates an apparatus according to various examples of the present techniques;

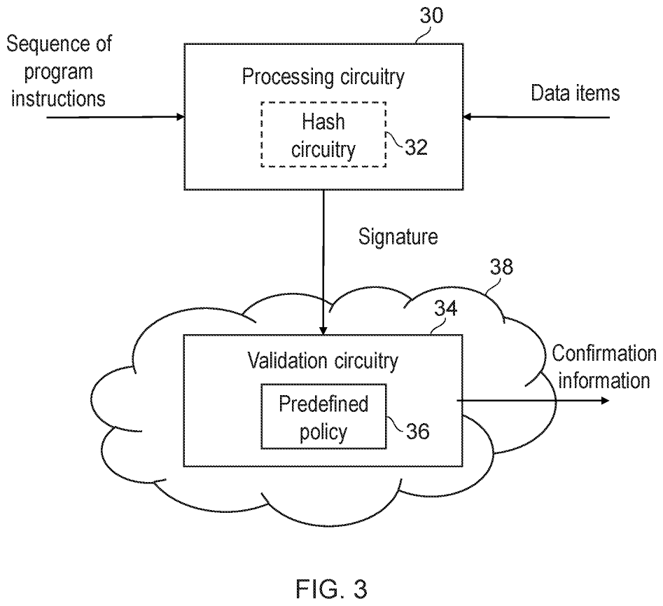

FIG. 3 schematically illustrates an apparatus according to various examples of the present techniques;

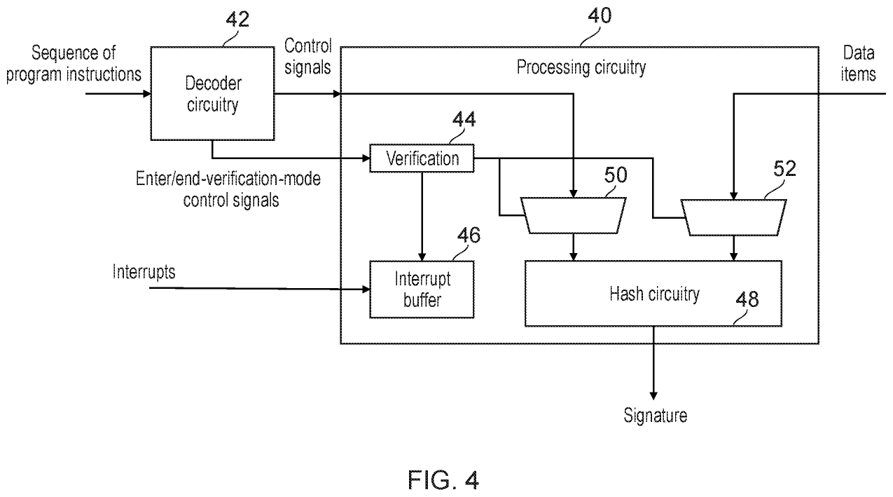

FIG. 4 schematically illustrates an apparatus according to various examples of the present techniques;

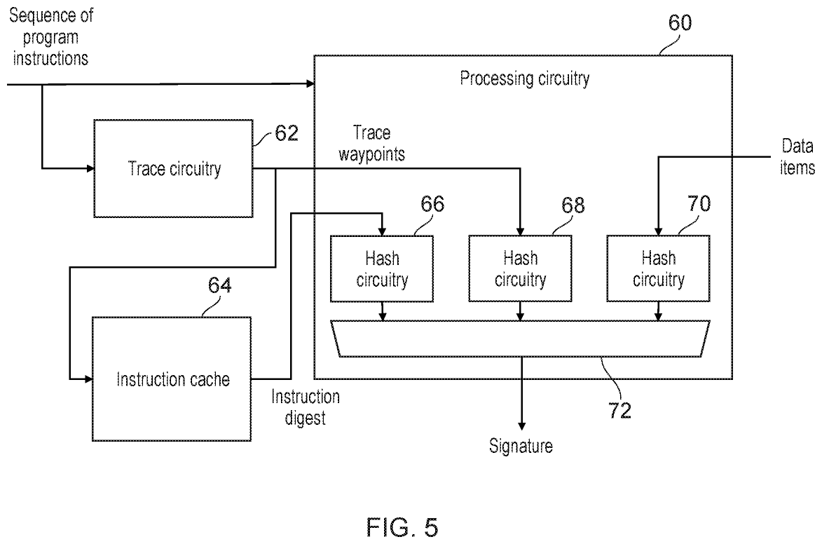

FIG. 5 schematically illustrates an apparatus according to various examples of the present techniques;

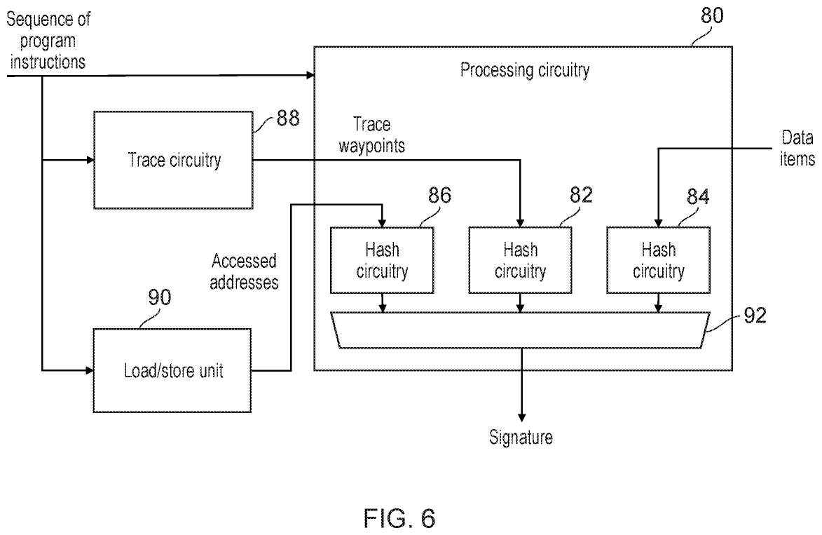

FIG. 6 schematically illustrates an apparatus according to various examples of the present techniques;

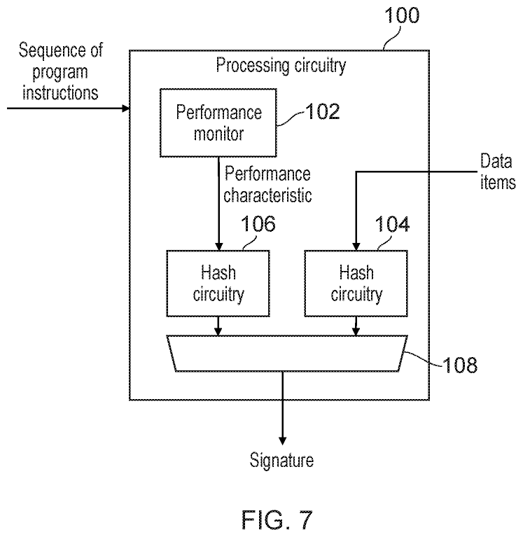

FIG. 7 schematically illustrates an apparatus according to various examples of the present techniques;

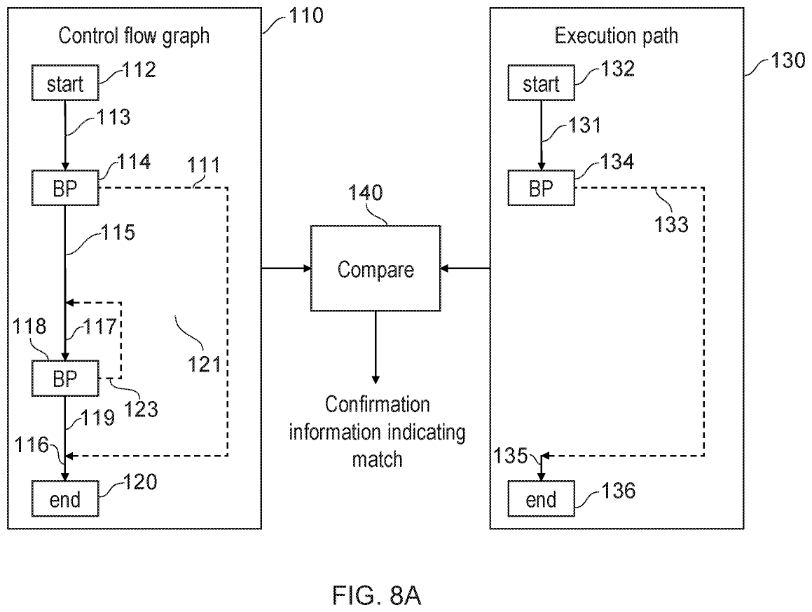

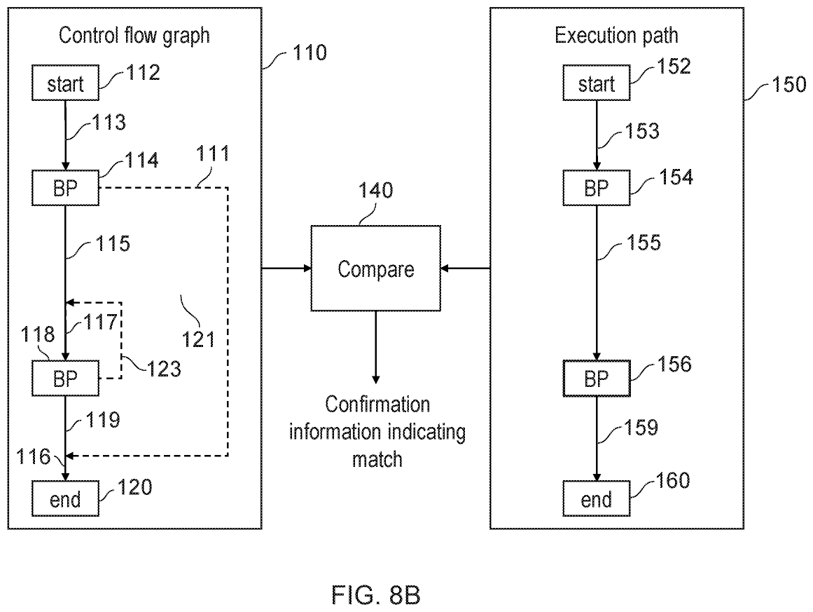

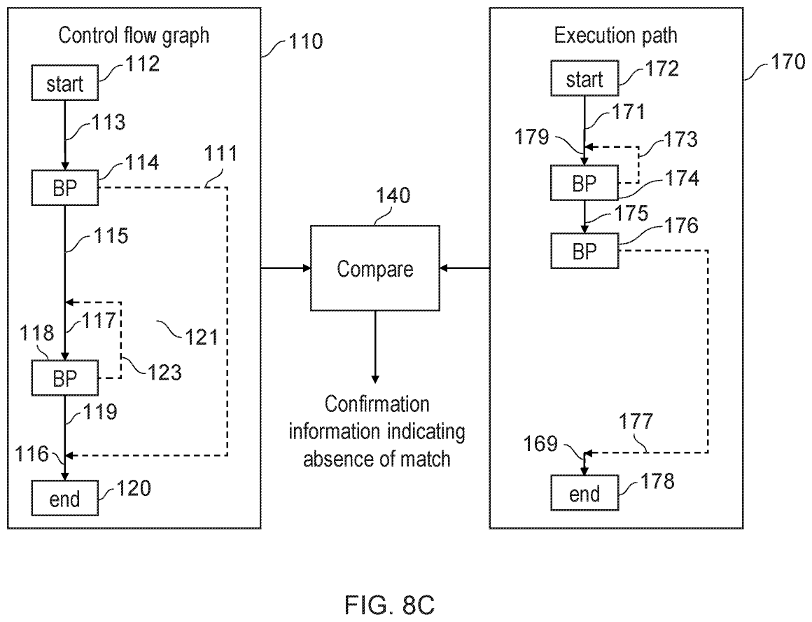

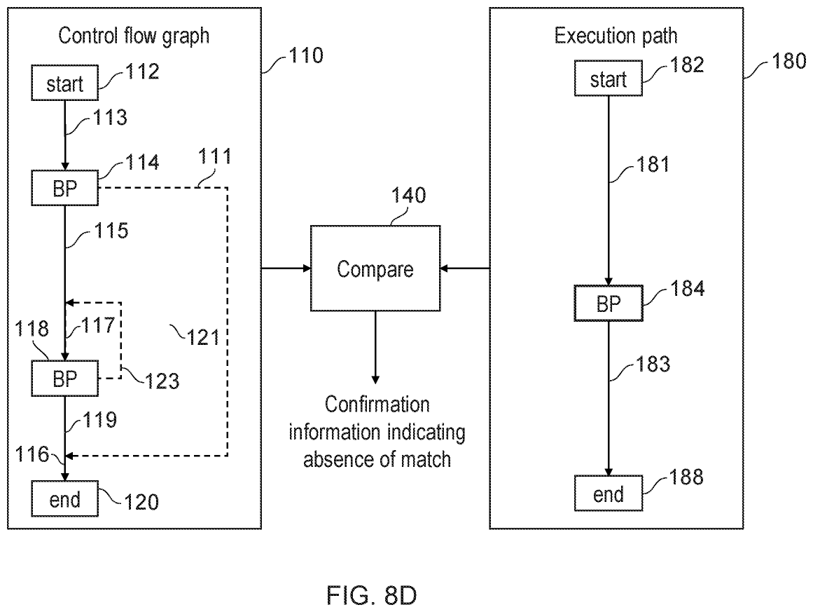

FIG. 8a schematically illustrates the comparison of an execution path to a control flow graph according to various examples of the present techniques;

FIG. 8b schematically illustrates the comparison of an execution path to a control flow graph according to various examples of the present techniques;

FIG. 8c schematically illustrates the comparison of an execution path to a control flow graph according to various examples of the present techniques;

FIG. 8d schematically illustrates the comparison of an execution path to a control flow graph according to various examples of the present techniques;

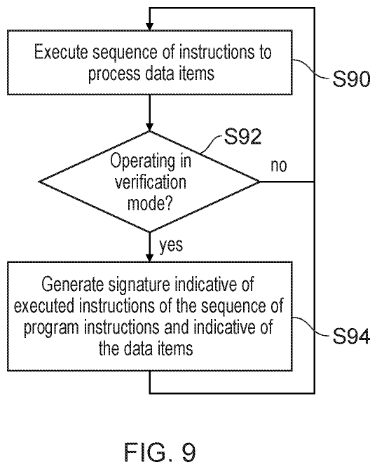

FIG. 9 schematically illustrates a sequence of steps taken by an apparatus according to various examples of the present techniques;

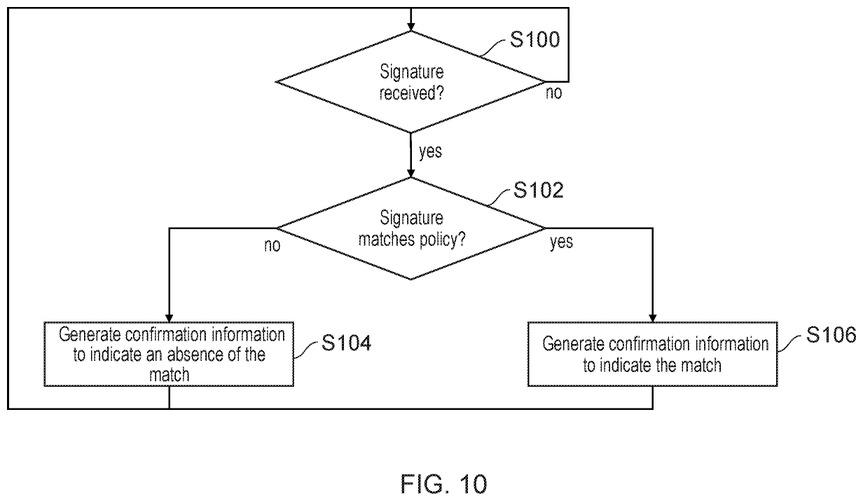

FIG. 10 schematically illustrates a sequence of steps taken by an apparatus according to various examples of the present techniques;

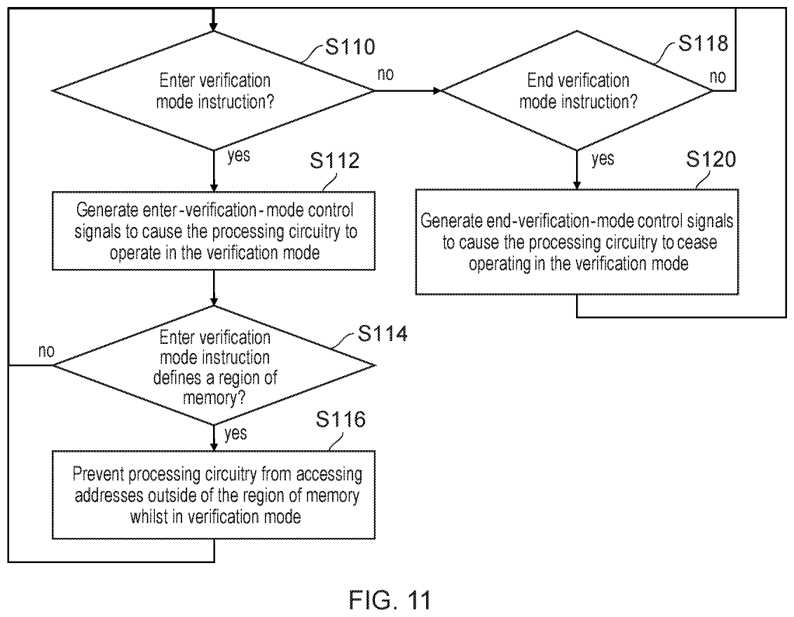

FIG. 11 schematically illustrates a sequence of steps taken by an apparatus according to various examples of the present techniques;

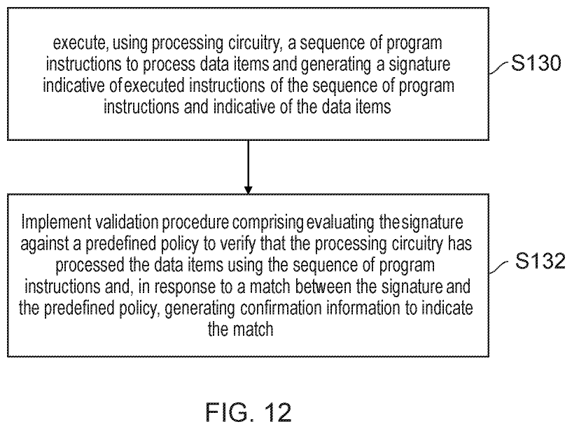

FIG. 12 schematically illustrates a sequence of steps taken by an apparatus according to various examples of the present techniques; and

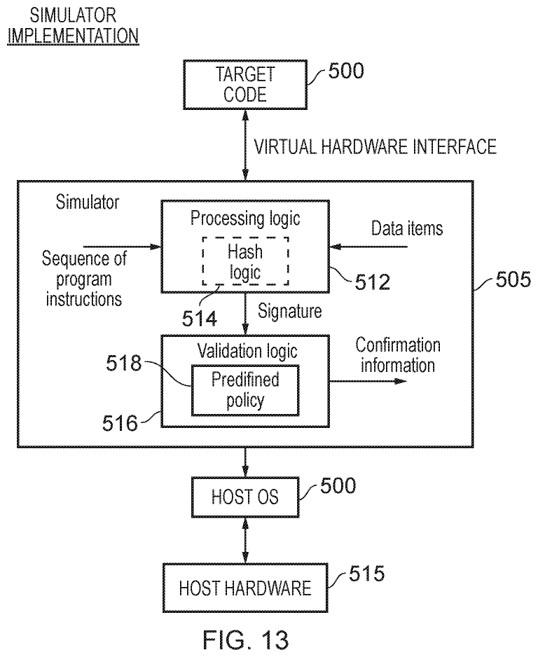

FIG. 13 schematically illustrates a simulator implementation of an apparatus according to various examples of the present techniques.

According to some configurations there is provided an apparatus comprising: processing circuitry configured to execute a sequence of program instructions to process data items, wherein the processing circuitry is configured to generate a signature indicative of executed instructions in the sequence of program instructions and indicative of the data items; and validation circuitry configured to implement a validation procedure comprising evaluating the signature against a predefined policy to verify that the processing circuitry has processed the data items using the sequence of program instructions and, in response to a match between the signature and the predefined policy, generating confirmation information to indicate the match.

The processing circuitry is arranged to process the sequence of program instructions. The processing instructions specify one or more data items which are processed by the processing circuitry according to the processing instructions. In order to verify that the processing circuitry has executed the required instructions and that the processing circuitry has processed the data items, the processing circuitry is arranged to generate a signature that is indicative of the processing and that is subsequently used to validate the execution of the sequence of instructions. The inventors have realised that, in order to validate that both the correct instructions have been executed and that the correct data has been used, the signature should be indicative of both of the executed instructions and of the data items. The signature therefore comprises instruction signature data indicative of which instructions have been executed and data-item signature data indicative of which data items have been processed when executing the sequence of instructions. In addition, there is provided validation circuitry which is arranged to evaluate (compare) the signature against a predefined policy and, when the validation circuitry determines that there is a match between the predefined policy and the signature, the validation circuitry is arranged to generate confirmation information. The confirmation information indicates that the validation circuitry has analysed the signature produced by the processing circuitry and that the sequence of instructions have processed the data items as expected.

In some configurations the processing circuitry is arranged to generate the signature based on a single use code indicative of an instance of processing of the data items using the sequence of program instructions. The single use code may be a nonce (number used once) and may be used to mitigate against replay attacks where an attacker attempts to transmit the same information a second time in order to determine information relating to the processing circuitry or validation circuitry. The presence of the single use code prevents this type of attack because an entity reliant on the signature can determine that the single use code has already been used and, hence, can disregard the attempt retransmission of data.

Whilst the processing circuitry and validation circuitry may be comprised in the same hardware as the entity which is instructing the processing, in some configurations the processing circuitry is arrange to at least one of: receive the single use code from an external party instructing the processing of the data items using the sequence of program instructions; and generate the single use code as a code that is predictable by the external party. Cases in which an external party, i.e., a party (entity or other apparatus) that is implemented on a physically separate and distinct integrate circuit to the processing circuitry, are potentially more vulnerable to replay attacks. In such cases the inclusion of the single use code prevents falsification of data through the reuse or retransmission of the signature and/or confirmation information because such information is generated using the single use code and, hence, the external party can determine that repeated information is attempting to reuse a single use code and can therefore disregard this information and/or otherwise take corrective action. The single use code can be provided either directly or indirectly from the external party, for example, as an encrypted single use code and/or as a randomly generated single use code. Alternatively, the single use code can be generated in a manner that is predictable by the external party, for example, the single use code could be generated based on a previously shared secret modified based on a timestamp indicative of a time or data at which the processing of the data items has occurred or can be generated based on information supplied by the external party at the time of instructing the processing.

The predefined policy can be defined in a number of ways. In some configurations the predefined policy comprises information indicative of one or more possible execution paths of the sequence of instructions. A sequence of instructions may comprise a number of different types of instructions. In some configurations the instructions are instructions of an instruction set architecture (ISA) that provides a complete set of instructions that can be provided by a compiler/programmer to instruct (control) the processing circuitry. The instructions comprise control flow altering instructions, for example, branch instructions, which may result in a deviation of order of execution from the defined program counter order, and non-flow altering instructions, for example, arithmetic instructions. When flow altering instructions are present, the next instructions executed by the program will be dependent on the outcome of the execution of the branch instructions which, in turn, may be dependent on the data items being processed. In this way a single program can have multiple possible execution paths for different data items. These instruction execution paths can be combined into a policy that is indicative of a plurality of these paths. The resulting policy can then be used to validate whether one of the plurality of possible paths has been taken. In some alternative configurations the policy is indicative of a portion of the sequence of instructions corresponding to a portion of an execution path that is the same for all possible execution sequences associated with that sequence of instructions. For example, in such configurations, the policy could comprise information indicative of the sequence of instructions up to the first flow altering instruction.

In some configurations the one or more possible execution paths comprises all permitted execution paths. Providing a predefined policy that is indicative of all possible execution paths reduces the likelihood of false negative results being returned by the validation circuitry. In some configurations the all permitted execution paths comprises all possible execution paths.

In some configurations the information indicative of the one or more possible execution paths is provided as a control flow graph. The control flow graph is indicative of each of the one or more possible execution paths of the sequence of instructions. A node of the control flow graph corresponds to a flow altering instruction and edges of the control flow graph, that connect two nodes of the control flow graph, correspond to one or more non-flow altering instructions that occur between the two flow altering instructions in the sequence of instructions. In some configurations, the instructions that occur between the two flow altering instructions are represented by providing details of a type of each instruction and any data registers that are represented by the instructions. Such implementations provide a high degree of assurance when validating the signature against the control flow graph. In other configurations, the instructions that occur between the two flow altering instructions are represented by providing an indication of a number of instruction cycles. In further alternative configurations, the instructions that occur between the two flow altering instructions are not directly represented with only the flow altering instructions represented in the control flow graph. The provision of less information in the control flow graph results in a more compact policy and a simpler validation process.

In some configurations the signature comprises information indicative of an execution path taken by the processing circuitry during execution of the sequence of instructions, and the validation procedure comprises comparing the execution path against the control flow graph. At the time of execution, the processing circuitry might not have knowledge of all permitted paths through the sequence of instructions. Therefore, the signature only contains information relating to the path that has been taken in the sequence of instructions during execution. Comparing the information indicative of the execution path against the control flow graph comprises ascertaining whether the execution path corresponds to one of the possible execution paths that comprise the control flow graph. Comparison can be achieved by a direct comparison to see if any of the possible paths is identical to the path taken by the processing circuitry. Alternatively, the validation circuitry can take a sequential approach and determine whether following the execution path, as indicated in the signature, through the control flow graph deviates from the possible paths as indicated in the control flow graph.

In some configurations, the predefined policy is generated based on at least one of: static analysis of the sequence of program instructions; and unit testing of the sequence of program instructions. Static analysis can be based on the program source code and may be generated as part of a compiling process. Generating a policy in this way provides an automated procedure that results in a policy that consistently reflects the sequence of instructions. In alternative configurations, the policy can be specified directly by a programmer. Unit testing comprises performing one or more tests to determine operation of the sequence of program instructions. Typically, unit testing is performed to ensure correct operation of a sequence of program instructions but can also be used to generate a policy that reflects the sequence of instructions.

The processing circuitry can be configured to generate the signature by taking information from a variety of sources. In some configurations the signature comprises a representation of each of the executed instructions and a lossless representation of the data items. In this approach, the signature comprises a comprehensive representation of the data items and of the instructions that are used to process the data items. Such an approach provides a high level of verification that the processing circuitry has executed the sequence of instructions to process the data items.

In some configurations the processing circuitry comprises a hash engine configured to generate the signature using a lossy hash function. The use of a lossy hash function reduces the total amount of signature data resulting in lower computation demands on the validation circuitry and a reduction in data overhead. Furthermore, the use of a lossy hash function reduces the amount of data that needs to be stored and increases the difficulty of reverse engineering the hash function, thereby reducing the chance that a signature could be falsified.

In some configurations the processing circuitry comprises a hash engine configured to generate the signature using a cryptographic hash function. The use of a cryptographic hash function further reduces the chance that a signature could be falsified.

Whilst some configurations provide an apparatus in which the processing circuitry is constantly operating to produce signature data, in some configurations the processing circuitry is operable in a verification mode, and the processing circuitry is configured: when operating in the verification mode, to generate the signature indicative of executed instructions in the sequence of program instructions and indicative of the data items; and when operating in a mode other than the verification mode, to process the sequence of instructions without generating the signature. By providing these two modes, the generation of the signature is performed specifically when processing sequences of instructions for which validation is required. This approach reduces the generation of unnecessary data resulting in a lower computational cost and reduced power consumption of the processing apparatus. Furthermore, by only considering a portion of the program that is operating in a verification mode, the generation of the policy is simplified as the policy need only cover the portion of the sequence of program instructions for which the data processing operations is arranged to operate in the verification mode.

In some configurations the apparatus further comprises decoder circuitry configured to receive the sequence of program instructions and to generate control signals to cause the processing circuitry to execute the sequence of program instructions, wherein the decoder circuitry is responsive to an enter verification mode instruction, to generate enter verification mode control signals to cause the processing circuitry to operate in the verification mode. The decoder circuitry translates each of the sequence of instructions to control signals that can be used to cause the processing circuitry to operate according to that instruction. The instructions that the decoder circuitry is arranged to decode are those that form an instruction set architecture. The instruction set architecture is a complete set of instructions that can be specified by a programmer or a compiler in order to control the processing circuitry. In these configurations, the decoder circuitry is responsive to the enter verification mode instruction, which is an instruction of the instruction set architecture, to enter the verification mode. In some configurations the decoder circuitry and the processing circuitry are implemented as discrete circuit blocks that interact with one another. In other configurations, the decoder circuitry and the processing circuitry are implemented as a single circuit that performs the functions of both the processing circuitry and the decoder circuitry.

In some configurations the decoder circuitry is responsive to the enter verification mode instruction specifying a region of memory, to prevent the processing circuitry from accessing addresses outside of the region of memory. The region of memory can be specified, for example, by providing at least one range of memory addresses that are to be accessible to the processing circuitry when operating in the verification mode. The at least one range of memory addresses can be provided as an additional argument specified as part of the enter verification mode instruction. Alternatively, the region of memory can be specified in a register that is referenced in the enter verification mode instruction or could be provided as a special function register which is implicitly indicated through the use of the enter verification mode instruction. The processing circuitry is arranged, when operating in the verification mode with a specified range of addresses, to monitor load and store requests, for example, by monitoring addresses accessed by the load/store unit, in order to determine whether an attempt is made to access an address outside of the range of addresses. In some configurations the processing circuitry will raise an exception in response to an attempt to access an address outside of the range of addresses. The provision of the restriction to within the region of memory provides further assurance that the processing circuitry has processed the data items as expected. In some configurations, the begin verification mode instruction is arranged to indicate a duration of the verification mode, for example, as a number of instruction cycles.

In some configurations the decoder circuitry is responsive to an end-verification-mode instruction, to generate end verification mode control signals to cause the processing circuitry to cease operating in the verification mode. The end verification mode instruction is an instruction of the instruction set architecture. When combined with the begin verification mode instruction the end verification mode instruction provides a tool that can be used by a programmer to control when the apparatus is arranged to perform validation of the sequence of instructions.

In some configurations the processing circuitry is configured, when in the verification mode, to defer acting on any interrupts until the processing circuitry has ceased operating in the verification mode. For interrupts that are generated as a result of the sequence of program instructions for which the signature is being generated, the processing circuitry is arranged to initially defer the interrupts and to exit the verification mode in order to deal with those interrupts. In this way, interrupts generated by the program instructions are also deferred until the processing circuitry has ceased to operate in the verification mode. The deferral of instructions may comprise deferring the interrupts in time, for example, until such time as the processing circuitry has ceased to operate in the verification mode or to defer the interrupts to another core in a multi-core system. By deferring interrupts that are received whilst the processing circuitry is in the verification mode, further assurance can be provided that the processing circuitry has performed processing of the data items as expected. Furthermore, deferring interrupts whilst operating in the verification mode prevents the flow of instructions from being misdirected, thereby increasing security. In some configurations a buffer is provided to buffer the interrupts until the processing circuitry has ceased operating in the verification mode.

The apparatus provides assurance that the processing circuitry has performed processing of the sequence of instructions on the data items. In particular, validating the signature that is generated against a policy provides verification that the processing circuitry has operated as expected. Whilst this can be performed directly by the processing circuitry which, in some configurations, comprises the validation circuitry. In other configurations the policy is accessible to the validation circuitry and is inaccessible outside of the validation circuitry. By restricting the policy such that it is inaccessible outside of the validation circuitry, further assurance can be obtained that the policy has not been maliciously modified by the processing circuitry to falsify the confirmation information. In some configurations the policy is accessible and writable by the validation circuitry when the validation circuitry is in a mode other than the verification mode and is accessible as a read-only policy once the validation circuitry enters the verification mode. For configurations in which a policy is provided by an external party (external entity), the policy may be a cryptographically signed policy indicative that the policy can be trusted by the validation circuitry.

The restriction of the policy to the validation circuitry can be achieved in a variety of ways. In some configurations the processing circuitry comprises the validation circuitry and the validation procedure is implemented in a realm of the processing circuitry, and the policy is accessible to the realm and is inaccessible outside of the realm. A realm is an isolated environment that is typically allocated its own region of address space that is often inaccessible from outside of the realm. The provision of a realm in which the validation procedure is implemented, provides assurance that access to the policy is restricted such that it is only accessible within the realm and is inaccessible outside of the realm. This approach provides a particularly lightweight implementation of the validation circuitry whilst maintaining the added assurance that the policy cannot be falsified by the processing circuitry.

In some configurations the processing circuitry is implemented within an integrated circuit; the validation circuitry is non-local validation circuitry external to the integrated circuit; and the processing circuitry is configured to transmit the signature to the non-local validation circuitry. The validation circuitry can be provided, for example, in a separate processor core, on a separate computer, or as part of a cloud computing environment. As a result, the validation procedure is implemented external to the processing circuitry thereby reducing the possibility that a result of the validation procedure could be falsified.

In some configurations the processing circuitry is configured, prior to the transmission of the signature to the non-local validation circuitry, to perform a cryptographic authentication process to generate, as the signature, a cryptographically authenticated signature. The process of cryptographically signing the signature provides assurance to the validation circuitry that the signature has been generated by the processing circuitry that processed the data items using the sequence of instructions. In some configurations, the processing circuitry is provided with a nonce (number to be used once) on which to base the cryptographic authentication thereby providing a further means to assure the validation circuitry that the signature has been generated by the processing circuitry that processed the data items using the sequence of instructions.

The signature data can comprise data from a variety of sources. In some configurations the processing apparatus further comprises trace circuitry configured to output trace data indicative of trace waypoints in the sequence of instructions, wherein the processing circuitry is configured to generate the signature comprising the trace data. Trace circuitry is often provided for the purpose of analysing the execution of software subsequent to the execution and without interrupting the execution of the software. Trace waypoints define instructions within the sequence of instructions that can be used to reconstruct the full sequence of instructions executed by the processing circuitry (for example, trace waypoints may record the execution of flow altering instructions such as branch instructions). By repurposing existing trace circuitry to provide waypoint data that is used to form the signature, a particularly lightweight implementation can be provided.

In some configurations the apparatus comprises an instruction cache, wherein the processing circuitry is configured to generate the signature comprising information indicative of instructions stored in the instruction cache that are scheduled for operation between the trace waypoints. It is technically possible that two different sequences of instructions could generate the same trace waypoints (for example, by generating a modified set of instructions through the replacement of non-flow altering instructions in an existing set of instructions). By combining the trace waypoint information with information indicative of instructions stored in the instruction cache, the complete sequence of instructions that are executed by the processing circuitry can be encoded into the signature thereby providing further assurance that the expected code has executed whilst maintaining the advantageous use of existing trace circuitry. In some configurations, the information indicative of instructions is incorporated into the signature as a complete list of instructions that occur between waypoints. In some configurations, the information indicative of instructions is encoded, for example, using a lossy hash function, before incorporation into the signature.

In some configurations the signature comprises a hash of the data items. In some configurations the signature comprises information indicative of a region of memory used by the sequence of program instructions. The information indicative of the region of memory may be incorporated as a complete list of accessed addresses, a range of accessed addresses, or a hash the range/address information. The hash used may be a lossy hash or a cryptographic hash.

In addition, or as an alternative, to the direct measurements of the instructions that are executed, an indirect measure of the instructions that have been executed can be used. In some configurations the signature comprises information indicative of performance characteristics of the processing circuitry during execution of the sequence of instructions. The information indicative of performance characteristics may comprise an indication of a number of instruction cycles that occur between branch instructions, or an indication of a number of instruction cycles during which a particular resource of the processing circuitry has been used.

In addition to generating information indicative of a match between the signature and the predefined policy, in some configurations the validation circuitry is responsive to an absence of the match between the signature and the predefined policy, to generate information indicative of the absence of the match. The information indicative of the absence of the match provides a direct measure that the processing circuitry has not processed the instructions as expected and/or has not used the data items that are expected. Such information can be used to inform a determination relating to the trustworthiness of a particular processing apparatus. In some configurations, the apparatus is configured to perform a particular error action in response to the information indicative of an absence of a match. In some configurations, the particular error action is raising an exception. The information indicative of the absence of the match may, in some configurations, comprise a signed indication that no match has been found. In other configurations the information indicative of the absence of the match comprises information indicative of the actual path (the signature) and information indicative of the expected path within a cryptographically signed data structure.

Particular configurations will now be described with reference to the accompanying figures.

FIG. 1 schematically illustrates an apparatus 10 which is provided with processing circuitry 12 and validation circuitry 16. The processing circuitry 12 is arranged to receive a sequence of program instructions and one or more data items which are processed, by the processing circuitry 12, in a manner that is defined by the sequence of program instructions. The processing circuitry 12 is arranged to generate a signature that is characteristic of the processing instructions that are executed and that is characteristic of the data items that are processed. The signature may be generated based directly on the instructions, based on control signals within the processing circuitry 12, and/or using any other data indicative of the behaviour of the processing circuitry 12 during execution. The signals that are used to generate the signature may, optionally, be passed through hash circuitry 14 to generate a hashed version of the signature. In this example, the hash circuitry 14 is shown as being part of the processing circuitry 12 but of course the skilled person will appreciate that the hash circuitry could lie outside the processing circuitry 12. The apparatus 10 is arranged such that the signature is passed to validation circuitry 16. The purpose of the validation circuitry is to determine whether the signature that was generated by the processing circuitry matches a predefined policy 18. The predefined policy 18 is accessible to the validation circuitry 16 but is not accessible to the processing circuitry 12. The validation circuitry is also arranged to output confirmation information in response to a match between the signature and the predefined policy in order to provide a validation as to whether the processing circuitry 12 has processed the data items using the sequence of instructions. Again, the location of the predefined policy is not limited to the specific example shown in FIG. 1 and could be located outside the validation circuitry.

FIG. 2 schematically illustrates details of an apparatus in which the processing circuitry and validation circuitry 20 have been combined according to some configurations of the present techniques. The processing circuitry 20 is arranged to perform processing in a number of discrete realms. Specifically, the processing circuitry 20 hosts a non-secure realm 22. Software operating in the non-secure realm may, optionally, have access to hash circuitry 24. Execution of the sequence of program instructions to process the data items is carried out in the non-secure realm 22 which outputs a signature that is characteristic of the data items and of the sequence of processing instructions. The processing circuitry 20 also hosts a secure realm 26. The secure realm 26 is arranged so that it can access a particular region of memory in which the predefined policy 28 is stored. The particular region of memory that is accessible to the secure realm 26 is not accessible to the processing circuitry 20 when it is not operating in the secure realm 26. The processing circuitry 20 operating in the secure realm 26 performs the function of the validation circuitry 16 referred to in FIG. 1. In particular, the secure realm 26 performs a validation procedure to determine whether or not there is a match between the signature that was generated in the non-secure realm and the predefined policy 28. In response to a match between the signature and the predefined policy 28, the processing circuitry 20 operating in the secure realm 26 generates and outputs confirmation information.

FIG. 3 schematically illustrates details of processing circuitry 30 according to some configurations of the present technique. The processing circuitry 30 is arranged to execute a sequence of program instructions to process data items and to generate a signature which may, optionally, be provided as a hash generated from information characteristic of the data items and from information characteristic of the sequence of program instructions that is generated by the processing circuitry 30. In the apparatus of FIG. 3, the validation procedure is not carried out locally on the processing circuitry 30. Instead, the processing circuitry 30 is arranged to transmit the signature off-chip to external validation circuitry 34. In the illustrated configuration the validation circuitry 34 is implemented in a cloud computing environment 38 that is external to the processing circuitry 30. The validation circuitry 34 is arranged to compare the signature to a predefined policy 36 and to generate the confirmation information based on an indication as to whether the signature matches the predefined policy 36.

FIG. 4 schematically illustrates further details of the processing circuitry 40 and decoder circuitry 42 according to various example configurations. The decoder circuitry 42 is arranged to receive the sequence of program instructions and to decode (interpret) the sequence of program instructions, which may be provided by a programmer or a compiler, in order to generate the control signals that are routed to the processing circuitry 40 to control which circuit blocks are activated in order to process the data items. The processing circuitry 40 is operable in a verification mode when a verification bit 44 is set. The value of the verification bit is set in response to an enter verification mode instruction of the sequence of program instructions to generate enter verification mode control signals that modify the value of the verification bit 44 to indicate that the processing circuitry 40 is to operate in the verification mode. The decoder circuitry 42 is also responsive to an end verification mode instruction to generate end verification mode control signals that modify the value of the verification bit 44 to indicate that the processing circuitry 40 is to operate in a mode other than the verification mode. Of course, in other embodiments, the verification mode could be entered by the clearing of the verification bit.

When operating in the verification mode, the switches 50 and 52 are activated so that the control signals generated by the decoder circuitry 40, in addition to causing the processing circuitry 40 to operate in a particular way in response to the sequence of programming instructions, are passed through the switch 50 to the hash circuitry 48. Similarly, the data items, in addition to being used as data inputs for the processing circuitry 40, are passed through the switch 52 to the hash circuitry 48. The hash circuitry 48 combines the data items and the control signals and generates a hash that is indicative of the data items and of the sequence of program instructions that are provided to the decoder circuitry.

The processing circuitry 40 is also arranged so that, when the verification bit 44 indicates that the processing circuitry 40 is operating in the verification mode, any interrupts that are received by the processing circuitry 40 are not immediately acted upon but, instead, are stored in the interrupt buffer 46 to be acted upon once the processing circuitry has been set to operate in a mode other than the verification mode.

In some configurations, the verification bit 44 can be implemented as a control register or as a logical signal that is held to a set value (for example logical one or logical zero) when the processing circuitry 40 is to be operated in the verification mode, and that is held to a clear value (for example, the other of logical one and logical zero) when the processing circuitry 40 is to be operated in a mode other than the verification mode. The verification bit can be provided as an individual bit that is stored by the processing circuitry 40 for the purpose of indicating whether the processing circuitry 40 is in the verification mode or not. Alternatively, the verification bit can be encoded as part of a general control register that is accessible to the processing circuitry 40.

FIG. 5 schematically illustrates details of processing circuitry 60 in accordance with some configurations of the present techniques. In addition to the processing circuitry 60, trace circuitry 62 and an instruction cache 64 are provided. The trace circuitry 62 is arranged to receive instructions of the sequence of instructions and to generate trace waypoints that indicate an order of execution of the sequence of program instructions. The trace waypoints comprise sufficient information that, when combined with the sequence of instructions in original program order (i.e., the order in which the instructions are initially written but not necessarily the order in which they are executed), the order of execution can be determined. For example, the sequence of instructions may comprise one or more flow altering instructions such as a branch instruction. The trace circuitry 62 records, as a trace waypoint, an indication of the flow altering instruction (e.g., the program counter value), and an indication (e.g., the program counter value) as to where the flow altering instruction causes flow to branch to. The trace waypoints are provided from the trace circuitry 62 to the processing circuitry 60 which, when operating in the verification mode, passes the trace waypoints through hash circuitry 68 to be combined using combining circuitry 72 in order to generate the signature.

The trace waypoints provide information that is characteristic of the sequence of program instructions. However, in the illustrated configuration, further information relating to the sequence of program instructions is provided from the instruction cache 64. The trace waypoints are passed from the trace circuitry 62 to the instruction cache 64 in order to retrieve the blocks of instructions that are executed by the processing circuitry 60. The blocks of instructions are provided to the hash circuitry 66 of the processing circuitry 60 before being combined in the combination circuitry 72 to form part of the signature. In addition, data items that are processed by the processing circuitry 60 are passed through hash circuitry 70 and are provided to the combination circuitry 72 to form part of the signature.

In alternative configurations the hash circuitries 66, 68, 70 are provided as a single hash circuit that is located before or after the combination circuitry 72. Furthermore, the hash circuitries 66, 68, 70 and the combination circuitry 72 may be provided as a single circuit block that performs the functions of the hash circuitries 66, 68, 70 and the combination circuitry 72.

The specific sets of data that are used to generate the signature can be variously defined and are not restricted to the sets of data that are illustrated in FIGS. 4 and 5. FIG. 6 schematically illustrates a further alternative of data items indicative of the operation of the processing circuitry 80 according to some configurations. In addition to the processing circuitry 80, the apparatus is provided with trace circuitry 88 and a load/store unit 90. The processing circuitry 80 and the trace circuitry are arranged to interact with one another as described in relation to FIG. 5. In addition, the processing circuitry 80 is arranged to receive information indicative of addresses that have been accessed by the load/store unit 90 in response to the sequence of instructions. The load/store unit 90 is arranged to access addresses generated by the processing circuitry in response to the sequence of instructions and to pass information indicative of the addresses that have been accessed to the processing circuitry 80. The processing circuitry 80 is arranged to generate, using hash circuitry 86, a hash of the addresses accessed by the processing circuitry 80 which is combined with the hash of the trace waypoints, generated by hash circuitry 82, and the hash of the data items, generated by hash circuitry 84, to generate the signature.

The processing circuitry 80 generates the hash of accessed addresses by performing a hash of each address accessed. In alternative configurations, the processing circuitry 80 maintains a record of a range of addresses accessed, for example, by storing range information indicative of a lowest address and a highest address accessed by the processing circuitry.

FIG. 7 schematically illustrates a processing circuitry 100 according to some configurations of the present techniques. The processing circuitry 100 is provided with performance monitoring circuitry 102 which is arranged to generate a performance characteristic of the processing circuitry 100 when executing the sequence of program instructions to process the data items. The performance monitoring circuitry 102 tracks a number of instruction cycles that are required between particular instructions and outputs this information to the hash circuitry 106. A hash of the performance characteristic, generated by the hash circuitry 106 is combined by the combination circuitry 108 with a hash of the data items generated by the hash circuitry 104 to generate the signature. It would be readily apparent to the skilled person that the different data sources that are combined to generate the signature could be combined in any order and are not restricted to the combination set out in the specific examples provided in FIGS. 4 to 7.

FIGS. 8a-8d schematically illustrate the use of a control flow graph 110 to validate the characteristic signature that is output by the processing circuitry. The control flow graph 110 is generated a-priori by static analysis of the sequence of instructions that are to be executed. The control flow graph 110 contains information that is indicative of all permitted paths through the sequence of program instructions. By way of example, the control flow graph 110 comprises a start point 112 indicative of the start of the sequence of program instructions for which execution is to be validated. The start point 112 is optionally followed by one or more instructions that are non-flow-altering instructions 113. A digest of these instructions (information indicative of these instructions) is included in the control flow graph.

The non-flow-altering instructions are followed by a branch point which is recorded in the control flow graph as the branch point 114. Dependent on the data being executed, the flow of instructions may, at the branch point 114, take one of two possible paths. In a first instance, the flow of instructions continues, optionally via one or more non-flow altering instructions 115, 117, to the branch point 118. In a second instance, the flow of instructions branches from branch point 114, via branch path 111 (branch path 111 is indicated by a dashed line in the figure and does not involve any instructions being executed), optionally to one or more non-flow altering instructions 116 and to the end 120 of the sequence of program instructions for which the control flow graph is being generated.

When the flow of instructions reaches the branch point 118, the flow of instructions will take one of two possible paths. In a first instance, flow continues from the branch point 118, optionally via one or more non-flow-altering instructions 119, 116 to the end 120 of the sequence of flow altering instructions for which the control flow graph is being generated. In a second instance, flow branches from the branch point 118 via branch path 123 and returns, optionally via one or more non-flow-altering instructions 117, to the branch point 118.

Dependent on the data that is received by the processing circuitry, any execution of the sequence of instructions will follow a path between the start 112 of the control flow graph and the end 120 of the control flow graph. As a result, the processing circuitry will, when a sequence of instructions that corresponds to the control flow graph is executed, generate a signature indicative of a flow path between the start 112 and the end 120 that can be mapped onto the control flow graph 110. The control flow path will incorporate information indicative of at least some of the non-flow altering instructions 113, 115, 116, 117, 119, and at least some of the branch points 114, 118 that occur between the start 112, the end 120.

FIG. 8a schematically illustrates a first example of an execution path 130 generated by processing circuitry when processing a sequence of instructions. The execution path 130 comprises a start point 132, information indicative of one or more non-flow altering instructions 131, information indicative of a branch point 134 which causes the flow path to jump (via branch path 133), information indicative of one or more non-flow-altering instructions 135, and information indicative of the end point 136. The signature comprising the execution path 130, and the control flow graph 110 are compared by the validation circuitry using comparison circuit 140. The comparison circuit 140 determines whether the execution path 130 can be mapped onto the control flow graph 110.

In the case of FIG. 8a, the start point 132 of the execution path is compared against the start point 112 of the control flow graph, the one or more non-flow altering instructions 131 of the execution path 130 are compared against the non-flow altering instructions 113 of the control flow graph 110, and the branch point 134 of the execution path 130 is compared against the branch point 114 of the control flow graph 110. In this case, a match is determined between these portions of the execution path 130 and the corresponding portions of the control flow graph 110. Until this point, the control flow graph 110 indicates that there is only one possible execution path. Subsequent to the branch point 114, there are multiple possible execution paths that could result in a match between the execution path 130 and the control flow graph 110. As a result, the non-flow-altering instructions 135 of the control flow path are compared against the non-flow-altering instructions 115 and the non-flow altering instructions 116 of the control flow graph 110. In the illustrated configuration there is not a match between the non-flow altering instructions 135 of the execution path 130 and the non-flow altering instructions 115 of the control flow graph 110. However, there is a positive match between the non-flow altering instructions 135 of the execution path 130 and the non-flow altering instructions 116 of the control flow graph 110. Therefore, the comparison circuitry 140 now considers the end point 136 of the execution path 130 which is compared against the end point 120 of the control flow graph 110. In the illustrated configuration there is a positive match between the end point 136 of the execution path 130 and the end point 120 of the control flow graph 110. Hence, there is an overall positive match between the execution path 130 and the control flow graph 110 (indicated in the figure as a visually similar path to one of possible path of the control flow graph). As a result, the comparison circuitry 140 determines that there is a match between the execution path and the control flow graph 110 and outputs confirmation information indicating the match. In other words, the comparison circuitry 140 is able to determine that characteristic signature comprising execution path 130 has been generated by a sequence of instructions that comprises the sequence of instructions that were used to generate the control flow graph 110.

FIG. 8b schematically illustrates a second example of an execution path 150 generated by processing circuitry when processing a sequence of instructions. The execution path 150 comprises a start point 152, information indicative of one or more non-flow-altering instructions 153, information indicative of a branch point 154, information indicative of one or more non-flow-altering instructions 155, information indicative of a branch point 156, information indicative of one or more flow altering instructions 159, and information indicative of an end point 160. The signature comprising the execution path 150, and the control flow graph 110 are compared by the validation circuitry using comparison circuit 140. The comparison comprises determining whether the execution path 150 can be mapped onto any portion of the control flow graph 110.

In the illustrated example, the start point 152 of the execution path 150 is compared against the start point 112 of the control flow graph 110. The one or more non-flow altering instructions 153 of the execution path 150 are compared against the one or more non-flow altering instructions 113 of the control flow graph 110. The branch point 154 of the execution path 150 is compared against the branch point 114 of the control flow graph 110. In this case, a match is determined between these portions of the execution path 150 and the initial portion of the control flow graph 110. Until this point, the control flow graph 110 indicates that there is only one possible execution path. Subsequent to the branch point 114, there are multiple possible execution paths that could result in a match between the execution path 150 and the control flow graph 110. The non-flow altering instructions 155 of the execution path 150 are therefore compared against the non-flow altering instructions 115, 117 and the non-flow altering instructions 116 of the control flow graph 110. In the illustrated example, it is determined that the non-flow altering instructions 155 of the control flow path correspond to the non-flow altering instructions 115, 117 of the control flow graph 110 and do not correspond to the non-flow-altering instructions 116 of the control flow graph 110. Hence, it is determined that the execution path 150 cannot correspond to the path through the control flow graph 110 in which the one or more non-flow altering instructions 116 are the next instructions to be executed subsequent to branch instruction 114. The branch point 156 of the execution path 150 is compared against the branch point 118 of the control flow graph. Again, at this point, there are two possible routes that the execution path 150 could take through the control flow graph 110. Therefore, the non-flow altering instructions 159 of the control flow path 150 are compared against the non-flow altering instructions 117 and the non-flow altering instructions 119, 116 of the control flow graph 110. In the illustrated example, it is determined that the non-flow altering instructions 159 of the control flow path 150 correspond to the non-flow altering instructions 119, 116 of the control flow graph 110 and that the non-flow altering instructions 151 of the execution path 150 do not correspond to the non-flow altering instructions 117 of the control flow graph 110. Hence, it is determined that the execution path 150 cannot correspond to the path through the control flow graph 110 in which the one or more non-flow-altering instructions 117 are the next instructions to be executed after the branch point 118. Finally, the end point 160 of the execution path 150 is compared against the end point 120 of the control flow graph 110.

In the illustrated configuration there is a positive match between the branch points 154, 156, the non-flow altering instructions 153, 155, and 159, and the start and end points 152, 160 of the execution path 150 and the control flow graph 110 (indicated in the figure as a visually similar path to one of possible path of the control flow graph). As a result, the comparison circuitry 140 determines that there is a match between the execution path 150 and the control flow graph 110 and outputs confirmation information indicating the match. In other words, the comparison circuit is able to determine that characteristic signature comprising execution path 150 has been generated by a sequence of instructions that comprises the sequence of instructions that were used to generate the control flow graph 110.

FIG. 8c schematically illustrates a third example of an execution path 170 generated by the processing circuitry according to some configurations of the present techniques. The execution path 170 comprises start point 172, branch points 174, 176, non-flow-altering instructions 171, 175, 179, 169, and end point 178. The signature comprising the execution path 170, and the control flow graph 110 are compared by the validation circuitry using comparison circuit 140. The comparison comprises determining whether the execution path 170 can be mapped onto any portion of the control flow graph 110.

In the illustrated configuration, the start point 172 of the execution path 170 is compared to the start point 112 of the control flow graph 110. From the start point 172, the execution path 170 comprises the non-flow-altering instructions 171, 179 which are compared against the non-flow altering instructions 113 of the control flow graph 110. If the non-flow altering instructions 171, 179 of the execution path 170 do not match the non-flow altering instructions 113 of the control flow graph 110 then there is no possible path through the control flow graph 110 that corresponds to the execution path 170. If the non-flow altering instructions 171, 179 of the execution path 170 do match the non-flow altering instructions 113 of the control flow graph 110 then further comparison is required. The repeating branch point 174, which causes repetition of non-flow altering instructions 179 (via path 173)of the execution path 170 is compared against the branch point 114 of the control flow graph 110. As the branch point 114 of the control flow graph 110 is distinguished from the execution path 170 due to the difference in the path 111 of the control flow graph from the path 173 of the execution path, the comparison circuitry 140 is able to determine that the execution path 170 cannot be mapped onto the control flow graph 110 and the comparison circuitry outputs confirmation information indicating the absence of a match. In other words, the comparison circuit is able to determine that characteristic signature comprising execution path 170 has been generated by a sequence of instructions that are different to the sequence of instructions that was analysed in order to generate the control flow graph 110.

FIG. 8d schematically illustrates a fourth example of an execution path 180 generated by the processing circuitry according to some configurations of the present techniques. The execution path 180 comprises start point 182, branch point 184, non-flow-altering instructions 181, 183 and end point 188. The signature comprising the execution path 180, and the control flow graph 110 are compared by the validation circuitry using comparison circuit 140. The comparison comprises determining whether the execution path 180 can be mapped onto any portion of the control flow graph 110. In the illustrated configuration the start point 182 of the execution path 180 is compared against the start point 112 of the control flow graph. Then, the non-flow-altering instructions 181 are compared against the flow altering instructions 113 of the control flow graph 110. As is schematically illustrated through the visual difference between the non-flow-altering instructions 181 of the execution path 180 and the non-flow-altering instructions 113 of the control flow graph, there is not a match between the execution path 180 and the control flow graph 110. The comparison circuit 140 therefore is able to determine that there is no portion (edge) of the control flow graph 110 that corresponds to the non-flow-altering instructions 181 of the execution path 180 and the comparison circuit outputs confirmation information indicating the absence of a match. In other words, the comparison circuit is able to determine that characteristic signature comprising execution path 180 has been generated by a sequence of instructions that are different to the sequence of instructions that was analysed in order to generate the control flow graph 110.

Whilst the comparison between the execution paths in FIGS. 8a-8d have been described sequentially from the start point 112 of the control flow graph 110 to the end point 120 of the control flow graph 110, it would be readily apparent to the skilled person that such comparisons could be determined in parallel, for example, by comparing the execution paths of FIGS. 8a-8d against each possible path of the control flow graph 110. Furthermore, in some configurations, the comparison is based on waypoints indicative of flow altering instructions that provide an indication as to an outcome of the flow altering instruction (for example, taken or not taken). In such configurations, the validation circuitry can perform verification based only on the waypoint information thereby reducing the need to compare sequences of non-flow altering instructions.

FIG. 9 schematically illustrates a sequence of steps that are carried out by processing circuitry according to various configurations of the present techniques. Flow begins at step S90 where the processing circuitry receives data items and a sequence of instructions. The processing circuitry executes the sequence of instructions in order to process the data items. Flow then proceeds to step S92 where the processing circuitry determines whether or not the processing circuitry is operating in a verification mode. If it is determined that the processing circuitry is not operating in the verification mode then flow returns to step S90. On the other hand if, at step S92, it is determined that the processing circuitry is operating in the verification mode then flow proceeds to step S94 where the processing circuitry generates a signature indicative of the sequence of instructions and indicative of the data items. Flow then returns to step S90.

FIG. 10 schematically illustrates a sequence of steps that are carried out by validation circuitry according to various configurations of the present techniques. Flow begins at step S100 where it is determined if a signature is received by the validation circuitry. If no then flow remains at step S100 until a signature is received. On the other hand, if it is determined that a signature has been received, then flow proceeds to step S102. At step S102, it is determined whether the received signature matches the predefined policy. If, at step S102, there is a match between the signature and the predefined policy, then flow proceeds to step S106 where the validation circuitry generates confirmation information to indicate that there is a match between the signature and the predefined policy before flow returns to step S100. If, at step S102, it was determined that the signature does not match the predefined policy, then flow proceeds to step S104, where the validation circuitry generates confirmation information to indicate an absence of a match between the signature and the predefined policy before flow returns to step S100.

FIG. 11 schematically illustrates a sequence of steps that are carried out by decoder circuitry in order to determine whether the processing circuitry is operating in a verification mode. Flow begins at step S110 where it is determined, by the decoder circuitry, whether an enter verification mode instruction has been received. If yes, then flow proceeds to step S112 where the decoder circuitry generates enter-verification mode control signals to cause the processing circuitry to operate in the verification mode. Flow then proceeds to step S114 where it is determined whether the enter verification mode instruction defines a region of memory that is to be accessible to the processing circuitry whilst it is operating in the verification mode. If, at step S114, it is determined that there is no defined region of memory, then flow returns to step S110. If, at step S114, it is determined that there is a defined region of memory, then flow proceeds to step S116, where the decoder circuitry generates control signals to prevent the processing circuitry from accessing addresses outside of the region of memory that was defined in the enter-verification-mode instruction. Flow then returns to step S110. If, at step S110, it was determined that no enter verification mode instruction was received, then flow proceeds to step S118, where it is determined if an end verification mode instruction has been received. If no then flow returns to step S110. If, at step S118, it was determined that an end-verification mode instruction was received, then flow proceeds to step S120, where the decoder circuitry generates end-verification-mode control signals to cause the processing circuitry to cease operating in the verification mode. Flow then returns to step S110.

FIG. 12 schematically illustrates a sequence of steps carried out by the apparatus according to various configurations of the present techniques. Flow begins at step S130, where the apparatus executes, using processing circuitry, a sequence of program instructions to process data items and generates a signature that is indicative of executed instructions of the sequence of instructions and that is indicative of the data items. Flow then proceeds to step S132 there a validation procedure is implemented, the validation procedure comprises evaluation the signature against a predefined policy to verify that the processing circuitry has processed the data items using the sequence of program instructions and, in response to a match between the signature and the predefined policy, confirmation information to indicate the match is generated.

FIG. 13 illustrates a simulator implementation that may be used in some configurations. Whilst the earlier described examples implement the present invention in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically a simulator implementation may run on a host processor 515, optionally running a host operating system 510, supporting the simulator program 505. In some arrangements there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990, USENIX Conference, Pages 53 to 63.

To the extent that examples have previously been described with reference to particular hardware constructs or features, in a simulated implementation equivalent functionality may be provided by suitable software constructs or features. For example, particular circuitry may be provided in a simulated implementation as computer program logic. Similarly, memory hardware, such as register or cache, may be provided in a simulated implementation as a software data structure. Also, the apparatus schematically illustrated in FIGS. 1 to 7 could be emulated as a simulated apparatus used by the host operating system 510 by the simulator 505. In arrangements where one or more of the hardware elements referenced in the previously described examples are present on the host hardware (for example host processor 515), some simulated implementations may make use of the host hardware, where suitable.

The simulator program 505 may be stored on a computer readable storage medium (which may be a non-transitory medium), and provides a virtual hardware interface (instruction execution environment) to the target code 500 (which may include applications, operating systems and a hypervisor) which is the same as the hardware interface of the hardware architecture being modelled by the simulator program 505. Thus, the program instructions of the target code 500 may be executed from within the instruction execution environment using the simulator program 505, so that a host computer 515, which does not actually have the hardware features of the apparatus discussed in relation to the above figures, can emulate those features. By way of example, the simulator program may include processing program logic 512 to emulate the behaviour of the processing circuitry 12, validation logic 516 to emulate the behaviour of the validation circuitry and, optionally, hash logic 514 to emulate the behaviour of the hash circuitry 14. In addition, the simulator program may include processing program logic to emulate the behaviour of the additional features described in relation to any of FIGS. 2-7. Hence, the techniques described herein can in the example of FIG. 12 be performed in software by the simulator program 505.

In brief overall summary there is provided an apparatus, a method of operating the apparatus and a computer program for controlling a host data processing apparatus to provide an instruction execution environment equivalent to the apparatus. The apparatus comprises processing circuitry configured to execute a sequence of program instructions to process data items. The processing circuitry is configured to generate a signature indicative of executed instructions in the sequence of program instructions and indicative of the data items. The apparatus is also provided with validation circuitry configured to implement a validation procedure. The validation procedure comprises the steps of evaluating the signature against a predefined policy to verify that the processing circuitry has processed the data items using the sequence of program instructions and, in response to a match between the signature and the predefined policy, generating confirmation information to indicate the match.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative configurations have been described in detail herein with reference to the accompanying drawings, it is to be understood that the invention is not limited to those precise configurations, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
processing circuitry configured to execute a sequence of program instructions to process data items, wherein the processing circuitry is configured to generate a signature indicative of executed instructions in the sequence of program instructions and indicative of the data items; and
validation circuitry configured to implement a validation procedure including evaluating the signature against a predefined policy to verify that the processing circuitry has processed the data items using the sequence of program instructions and, in response to a match between the signature and the predefined policy, generating confirmation information to indicate the match.

2. The apparatus of claim 1, wherein: the processing circuitry is arranged to generate the signature based on a single use code indicative of an instance of processing of the data items using the sequence of program instructions.

3. The apparatus of claim 2, wherein the processing circuitry is arranged to at least one of:
receive the single use code from an external party instructing the processing of the data items using the sequence of program instructions; and
generate the single use code as a code that is predictable by the external party.

4. The apparatus of claim 1, wherein the predefined policy includes information indicative of one or more possible execution paths of the sequence of instructions.

5. The apparatus of claim 4, wherein the one or more possible execution paths included all permitted execution paths.

6. The apparatus of claim 4, wherein the information indicative of the one or more possible execution paths is provided as a control flow graph.

7. The apparatus of claim 6, wherein the signature includes information indicative of an execution path taken by the processing circuitry during execution of the sequence of instructions, and the validation procedure includes comparing the execution path against the control flow graph.

8. The apparatus of claim 1, wherein the predefined policy is generated based on at least one of:
static analysis of the sequence of program instructions; and
unit testing of the sequence of program instructions.

9. The apparatus of claim 1, wherein the signature comprises a representation of each of the executed instructions and a lossless representation of the data items.

10. (canceled)

11. The apparatus of claim 1, in which the processing circuitry is operable in a verification mode, and the processing circuitry is configured:
when operating in the verification mode, to generate the signature indicative of executed instructions in the sequence of program instructions and indicative of the data items; and
when operating in a mode other than the verification mode, to process the sequence of instructions without generating the signature.

12. The apparatus of claim 11, further comprising decoder circuitry configured to receive the sequence of program instructions and to generate control signals to cause the processing circuitry to execute the sequence of program instructions, wherein the decoder circuitry is responsive to an enter verification mode instruction, to generate enter verification mode control signals to cause the processing circuitry to operate in the verification mode.

13. The apparatus of claim 12, wherein the decoder circuitry is responsive to the enter verification mode instruction specifying a region of memory, to prevent the processing circuitry from accessing addresses outside of the region of memory.

14. The apparatus of claim 12, wherein the decoder circuitry is responsive to an end-verification-mode instruction, to generate end verification mode control signals to cause the processing circuitry to cease operating in the verification mode.

15. The apparatus of claim 11, wherein the processing circuitry is configured, when in the verification mode, to defer acting on any interrupts until the processing circuitry has ceased operating in the verification mode.

16. The apparatus of claim 1, wherein the policy is accessible to the validation circuitry and is inaccessible outside of the validation circuitry.

17. The apparatus of claim 1, wherein the processing circuitry comprises the validation circuitry and the validation procedure is implemented in a realm of the processing circuitry, and the policy is accessible to the realm and is inaccessible outside of the realm.

18. The apparatus of claim 1, wherein:
the processing circuitry is implemented within an integrated circuit;
the validation circuitry is non-local validation circuitry external to the integrated circuit; and
the processing circuitry is configured to transmit the signature to the non-local validation circuitry.

19. The apparatus of claim 18, in which the processing circuitry is configured, prior to the transmission of the signature to the non-local validation circuitry, to perform a cryptographic authentication process to generate, as the signature, a cryptographically authenticated signature.

20. (canceled)

21. (canceled)

22. (canceled)

23. (canceled)

24. A method of operating an apparatus comprising processing circuitry, the method comprising:
executing, using the processing circuitry, a sequence of program instructions to process data items and generating a signature indicative of executed instructions in the sequence of program instructions and indicative of the data items; and
implementing a validation procedure including evaluating the signature against a predefined policy to verify that the processing circuitry has processed the data items using the sequence of program instructions and, in response to a match between the signature and the predefined policy, generating confirmation information to indicate the match.

25. A computer program for controlling a host data processing apparatus to provide an instruction execution environment, including:
processing program logic configured to execute a sequence of program instructions to process data items, wherein the processing program logic is configured to generate a signature indicative of executed instructions in the sequence of program instructions and indicative of the data items; and
validation program logic configured to implement a validation procedure including evaluating the signature against a predefined policy to verify that the processing program logic has processed the data items using the sequence of program instructions and, in response to a match between the signature and the predefined policy, generating confirmation information to indicate the match.
